(19) United States
(12) Patent Application Publication
(10) Pub. No.: US 2023/0054774 A1
(43) Pub. Date: Feb. 23, 2023

(54) USER CONSTRAINED PROCESS MINING

(71) Applicant: UiPath, Inc., New York, NY (US)

(72) Inventors: Dennis BRONS, Eindhoven (NL); Roeland Johannus SCHEEPENS, Eindhoven (NL)

(73) Assignee: UiPath, Inc., New York, NY (US)

(21) Appl. No.: 17/644,799

(22) Filed: Dec. 17, 2021

Related U.S. Application Data
(63) Continuation-in-part of application No. 17/445,593, filed on Aug. 21, 2021.

(51) Int. Cl. G06F 9/50

(52) U.S. Cl. CPC G06F 9/5027

(57) ABSTRACT

Systems and methods for generating a process tree of a process are provided. An event log of execution of a process is received. User constraints on one or more activities of the process are received from a user. A process tree is generated from the event log based on the user constraints. The process tree is output. The user constraints comprise at least one of inclusion constraints defining one or more activities that must be represented in the process tree or exclusion constraints defining one or more activities that must not be represented in the process tree.

### TECHNICAL FIELD

The present invention relates generally to process mining, and more particularly to user constrained process mining.

### BACKGROUND

Processes are sequences of activities executed by one or more computers to provide various services. In process mining, processes are analyzed to identify trends, patterns, and other process analytical measures in order to improve efficiency and gain a better understanding of the processes. Conventional approaches for process mining are performed by interpreting event logs of processes to generate process trees of those processes. However, such conventional approaches for process mining do not utilize knowledge of the underlying processes. This can result in differences between the visual alignment of the process trees representing the interpretation of the processes during process mining and the underlying processes.

### BRIEF SUMMARY OF THE INVENTION

In accordance with one or more embodiments, systems and methods for generating a process tree of a process are provided. An event log of execution of a process is received. User constraints on one or more activities of the process are received from a user. A process tree is generated from the event log based on the user constraints. The process tree is output. In one embodiment, the process is an RPA (robotic process automation) process.

In one embodiment, the process tree is generated by constructing graphs based on the user constraints, defining clusters of activities that must not be split up based on the graphs, and splitting an event log of the process based on the clusters of activities.

In one embodiment, the user constraints comprise user constraints defining a sequence relationship between activities. The event log is split based on 1) an activity with a highest forward connectivity in a directed graph and 2) activities clustered with the activity with the highest forward connectivity in the clusters of activities.

In one embodiment, the user constraints comprise user constraints defining a loop relationship between activities. Activities of the process that correspond to a body of the loop relationship and a rework portion of the loop relationship are identified. In response to determining that two or more of the activities in the user constraints defining the loop relationship are identified to correspond to the body, one of the activities in the user constraints defining the loop relationship are placed in the body and remaining activities in the user constraints defining the loop relationship are placed in the rework portion. In response to determining that activities of each respective cluster are not split between the body and the rework portion, all activities of the respective cluster are placed in the same body or rework portion. In response to determining that activities of a particular cluster have not been assigned to the body or the rework portion, the activities of the particular cluster are placed in the body or the rework portion based on a frequency of occurrence of the activities of the particular cluster in the body and the rework portion.

In one embodiment, the user constraints comprise one or more of binary constraints defining relationships between two or more activities of the process and unary constraints defining behavior of a single activity of the process or a single set of activities of the process. The relationships may comprise at least one of a sequence relationship, an exclusive choice relationship, a parallel relationship, or a loop relationship. The unary constraints may define at least one of whether the single activity or the single set of activities is optional or mandatory or whether the single activity or the single set of activities must be able to repeat itself or must not be able to repeat itself.

In accordance with one or more embodiments, systems and methods for generating a process tree of a process are provided. An event log of execution of a process is received. User constraints on one or more activities of the process are received from a user. A process tree is generated from the event log based on the user constraints. The process tree is output. The user constraints comprise at least one of inclusion constraints defining one or more activities that must be represented in the process tree or exclusion constraints defining one or more activities that must not be represented in the process tree. In one embodiment, the process is an RPA process.

In one embodiment, the process tree is generated by extracting a plurality of activities from the event log, selecting activities from the plurality of activities based on the inclusion constraints and the exclusion constraints, and generating the process tree based on the selected activities. The selected activities comprise the one or more activities that must be represented in the process tree and do not comprise the one or more activities that must not be represented in the process tree.

These and other advantages of the invention will be apparent to those of ordinary skill in the art by reference to the following detailed description and the accompanying drawings.

### BRIEF DESCRIPTION OF THE DRAWINGS

FIG. 1 shows an illustrative process;

FIG. 2 shows a method for generating a process tree based on user constraints, in accordance with one or more embodiments;

FIG. 3 shows an exemplary event log of the process of FIG. 1;

FIG. 4 shows a table showing constraints, graphs, and clusters, in accordance with one or more embodiments;

FIG. 5A shows a process tree of a particular process generated using a unconstrained probabilistic inductive miner;

FIG. 5B shows a process tree of a particular process generated using a constrained probabilistic inductive miner in accordance with one or more embodiments; and

FIG. 6 is a block diagram of a computing system according to an embodiment of the invention.

### DETAILED DESCRIPTION

A process may be executed by one or more computers to provide services for a number of different applications, such as, e.g., administrative applications (e.g., onboarding a new employee), procure-to-pay applications (e.g., purchasing, invoice management, and facilitating payment), and information technology applications (e.g., ticketing systems). In one embodiment, the process may be an RPA (robotic process automation) process automatically executed by one or more RPA robots.

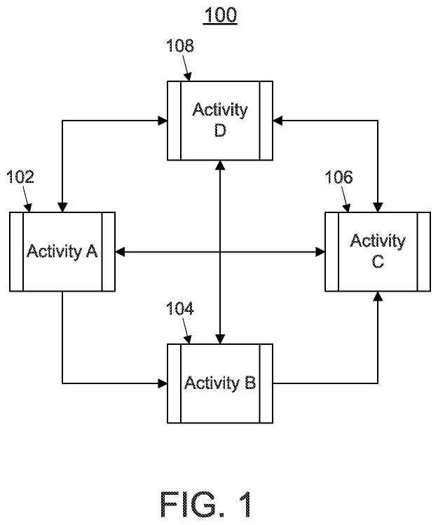

FIG. 1 shows an illustrative process 100. Process 100 comprises Activity A 102, Activity B 104, Activity C 106, and Activity D 108, which represent a predefined sequence of steps in process 100. Execution of process 100 is recorded in the form of an event log.

To facilitate user understanding of the execution of process 100, process mining may be performed to generate a process tree of process 100 based on its event log. The process tree is a visual representation of the execution of process 100. The process tree is modelled as a directed graph where each activity of the process is represented as a node and the execution of the process from a source activity to a destination activity is represented as an edge connecting the nodes representing the source activity and the destination activity. Each edge in the process tree may be associated with a number representing a frequency of execution of that edge.

Conventionally, process mining is performed to generate a process tree of a process based on the event log of the process without utilizing knowledge of the underlying process. As the process tree is generated without utilizing knowledge of the underlying process, the visual alignment of the process tree may differ from the underlying process.

Embodiments described herein provide for user-constrained process mining. Such user-constrained process mining enables a user to define constraints on the process mining of a process to thereby incorporate the user's knowledge of the process in the process mining. Advantageously, such user-constrained process mining generates more accurate process trees of processes, allowing for conformance checking on the processes.

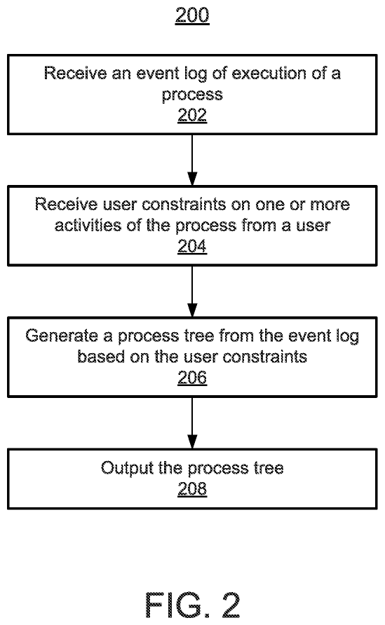

FIG. 2 shows a method 200 for generating a process tree based on user constraints, in accordance with one or more embodiments. The steps of method 200 may be performed by any suitable computing device, such as, e.g., computing system 1000 of FIG. 10.

At step 202, an event log of execution of a process is received. The event log may be maintained during one or more instances of execution of the process by recording events occurring during the one or more instances of execution of the process. An event refers to the execution of an activity at a particular time and for a particular case. A case corresponds to a particular instance of execution of the process and is identified by a case identifier (ID). A trace refers to an ordered sequence of activities executed for a case. A variant refers to a frequency of occurrence of a particular trace.

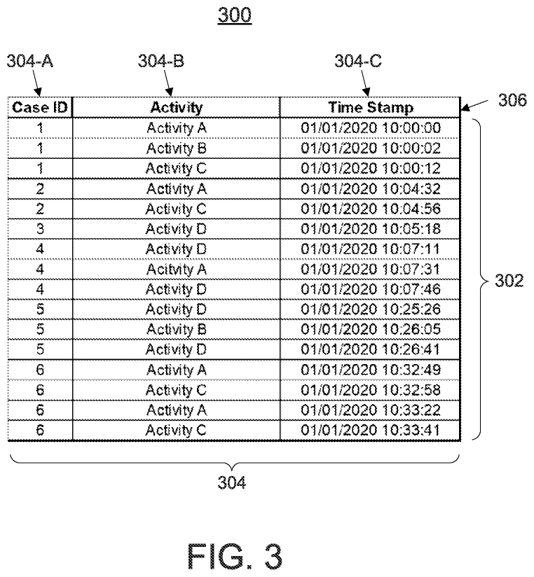

FIG. 3 shows an exemplary event log 300 of process 100 of FIG. 1, in accordance with one or more embodiments. Event log 300 records events occurring during six instances of execution of process 100, corresponding to case ID 1 through case ID 6 in event log 300. As shown in FIG. 3, event log 300 is formatted as a table having rows 302 each corresponding to an event and columns 304 each identifying an attribute of the event, identified in header row 306, at a cell at which rows 302 and columns 304 intersect. In particular, each row 302 is associated with an event representing the execution of an activity 102-108 (identified in column 304-B), a time stamp of the execution of the activity 102-108 (identified in column 304-C), and a case ID identifying the instance of execution of the executed activity 102-108 (identified in column 304-A). In one embodiment, the time stamp of the execution of the activity 102-108, identified in column 304-C, refers to the time at which execution of the activity 102-108 completed, but may alternatively refer to the time at which execution of the activity 104-108 started. It should be understood that event log 300 may be in any suitable format and may include additional columns 304 identifying other attributes of events.

At step 204, user constraints on one or more activities of the process are received from a user. The user constraints dictate the structure of the process tree of the process and represent the user's knowledge of the process. The user constraints may be any suitable constraints on one or more activities of the process. In one embodiment, the user constraints may be, for example, binary constraints and/or unary constraints. In another embodiment, the user constraints may be inclusion and exclusion constraints.

Binary constraints define relationships between two or more activities of the process. Exemplary relationships include a sequence relationship, an exclusive choice relationship, a parallel relationship, or a loop relationship. The sequence relationship of activity A to activity B, denoted A→B, indicates that activity B must occur after activity A and conversely that activity B must not occur before activity A. The exclusive choice relationship of activity A and activity B, denoted A×B, indicates that there must be a choice between activity A and activity B. The parallel relationship of activity A and activity B, denoted AΛB, indicates that activity A and activity B must be in parallel. The loop relationship of activity A and activity B, denoted A [symbol] B, indicates that activity A and activity B must be in a looping structure. In some embodiments, the binary constraints may define relationships between more than two activities. For example, the exclusive choice relationship of activity A, activity B, and activity C, denoted A×B×C, indicates that there must be a choice between activity A, activity B, and activity C.

Unary constraints define behavior of a single activity (or a single set of activities) of the process. For example, the unary constraints may indicate that activity A is optional and may be skipped, denoted as (A), or may indicate the activity A is mandatory and may not be skipped, denoted as !(A). The unary constraints may indicate that activity A must be able to repeat itself, denoted as [symbol] A, or may indicate that activity A must not be able to repeat itself, denoted as ! [symbol] A. In some embodiment, the unary constraints may define constraints on a single set of activities. For example, the unary constraints may indicate that activity A, activity B, and activity C may not be skipped, denoted as !(A, B, C). It is noted that unary constraint !(A, B, C) does not pose restrictions on the individual activities but on the set of activities.

Inclusion and exclusion constraints define one or more activities of the process that must be represented in or must not be represented in the process tree respectively. Not all activities in the event log are representative of the control flow that is portrayed in the process tree. The inclusion and exclusion constraints allow the user to define what activities should be part of the process tree and what activities should be excluded from the process tree. For example, the inclusion constraints may indicate that activity A and activity B must be represented in the process tree, denoted as incl: A, B. An exemplary use case is incl: Approve Invoice, Receive Invoice, denoting that the activities Approve Invoice and Receive Invoice must be represented in the process tree. In another example, the exclusion constraints may indicate that activity A and activity B must not be represented in the process tree, denoted as excl: A, B. An exemplary use case is excl: PO Change Amount, PO Change Address, denoting that the activities PO Change Amount and PO Change Address must not be represented in the process tree.

The user constraints may be received from the user interacting with a user interface, such as, e.g., display 610, keyboard 612, and/or cursor control device 614 of computing system 600. The user constraints may be defined by the user in any suitable format. In one embodiment, the user constraints may be defined by the user as denoted above. The expression of the user constraints may be extended to allow for more complex user constraints, for example, by combining atomic constraints such as (A×B)ΛC→D.

At step 206 of FIG. 2, a process tree is generated from the event log based on the user constraints. The process tree may be generated using any suitable approach.

In one embodiment, the process tree is generated by incorporating the user constraints into a probabilistic inductive miner. In general, the probabilistic inductive miner receives an event log of a process. It is determined whether a base case applies to the event log and, in response to determining that the base case applies to the event log, one or more nodes are added to the process tree. In response to determining that the base case does not apply to the event log, the event log is split into sub-event logs and one or more nodes are added to the process tree. The steps of determining whether a base case applies and splitting the event log are repeatedly performed for each respective sub-event log using the respective sub-event log as the event log until it is determined that the base case applies to the event log. The probabilistic inductive miner is known in the art and is further described in U.S. patent application Ser. No. 17/013,624, filed Sep. 6, 2020, the disclosure of which is incorporated herein by reference in its entirety.

Due to how the probabilistic inductive miner operates, the process tree is generated by splitting the event log according to the user constraints. For example, given a user constraint A→B, the event log (or sub-event log) will eventually be split or cut by a sequence cut to split activities A and B. If a non-sequence cut of activities A and B is performed, a sequence cut of activities A and B can never be performed thereafter. Accordingly, even though the constraint A→B is a constraint on the sequence relationship, it is also a restriction on every other relationship to not separate activities A and B, as this must be done through a sequence cut.

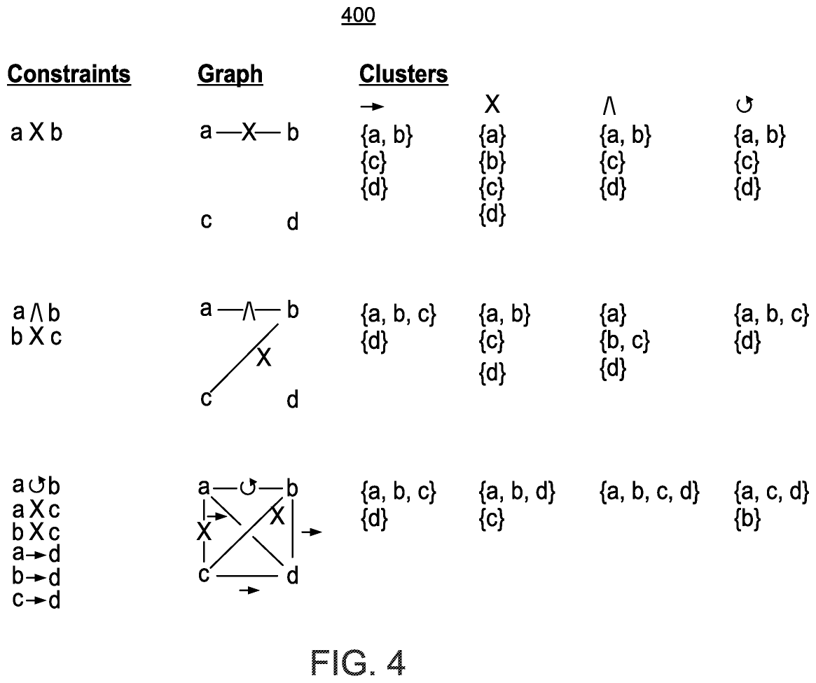

For binary constraints, to prevent cuts by the wrong relationship operator, constraint clusters of activities that must not be split up are defined based on the user constraints. To define the clusters, a graph is first constructed based on the user constraints. The graph comprises a node for every activity in the event log and, for every binary constraint, an edge between activity nodes for the constraints. The edges are annotated with the constraint type. The clusters of activities that must not be split up are then defined from the graph. For example, for a constraint defining an exclusive choice relationship, the constraints dictate that activities which are connected through constraints other than exclusive choice cannot be split up. Accordingly, for exclusive choice, the clusters are the components of the graph which are connected through edges which are connected through edges that are annotated with operators other than exclusive choice. FIG. 4 shows a table 400 showing constraints in the first column, the resulting constraint graph in the second column, and clusters of activities that must not be split up in the third column, in accordance with one or more embodiments. The clusters in table 400 are shown per operator for that graph. The event log (or sub-event log) is then split based on the clusters of activities.

For constraints defining exclusive choice and parallel relationships between activities, the probabilistic inductive miner already uses a form of clustering to split the event log. The probabilistic inductive miner applies the average minimum cut algorithm for determining cuts for exclusive choice and parallel relationships. The average minimum cut algorithm starts with every activity in the event log being its own cluster. From there, the algorithm starts merging all clusters repeatedly and keeps track of what cut between the clusters was the best option. Since the average minimum cut algorithm starts with all activities in their own clusters already, the clusters (of one activity each) are replaced with the clusters of activities that must not be split up. Accordingly, the clusters of activities can be directly provided to the average minimum cut algorithm of the probabilistic inductive miner as input.

For constraints defining sequence relationships between activities, the probabilistic minder splits the event log by constructing a directed graph, where the nodes are the activities of the event log and the edges are the directed sequence scores between the activities. The probabilistic inductive miner repeatedly calculates the best activity to be considered next, which is the activity that has the highest forward connectivity in the graph to the other activities that have not yet been visited. Activities clustered with the best activity in the cluster of activities are also included. If there is a set of activities from which all activities can be reached via a single edge, the sequence cluster is finished. From there, the first activity of the next cluster is chosen by selecting the activity that has the highest forward connectivity in the graph to the other activities that have not yet been visited. Steps are also taken to ensure the correct order. For example, given a constraint A→B but activity B is being considered before activity A. To ensure the order of A→B is not violated, a sequence cluster is defined with activity A before activity B such that the activities are split in the correct order.

For constraints defining loop relationships between activities, the first step is to identify which activities form the starting and end portions of both the body and the rework portion of the loop. The rework portion corresponds to the portion of the loop where the loop repeats from an activity at an end of an iteration to an activity at the beginning of a next iteration. Next, it is determined whether the loop constraints hold up. There is a single scenario in which the loop constraints do not hold up: when two or more of the activities in a loop constraint are identified to be in the loop body. This implies that they are not being split up, contradictory to the loop constraint. To address this, in response to determining that two or more of the activities in the loop constraint are identified in the loop body, one activity is determined to be best suited for the body, and the remainder activities are placed in the reword portion of the loop.

Next, it is checked whether activities that are clustered together (through the non-loop constraints) are split up between the body and the rework portion. If the clustered activities are split between the body and the rework portion, it is impossible to discover a loop structure that does not violate the constraints, so it is concluded that no loop cut is possible at this point. If the clustered activities are not split between the body and the rework portion, it is checked whether the clustered activities are in the body or the rework portion and place all clustered activities in that same body or rework portion.

Finally, if there are clusters which have not been assigned to the body or rework portion, it is checked whether the activities of the clusters occur more often between the body start/end or the rework start/end activities. The activities of each cluster are placed in the body or the rework portion where they occur more frequent (similar to how this is performed in loop cut detection). Loop cuts splitting sequential constraint activities are considered to be valid. Because of the looping structure, a strict ordering of activities is defined that does not violate the sequence constraint.

For inclusion and exclusion constraints, the probabilistic inductive miner extracts the set of unique activities from the event log. As process trees with a very large number of activities are visually jarring and difficult to utilize, the probabilistic inductive miner limits the number of the unique activities used in the process mining (e.g., 100 activities max). The probabilistic inductive miner sorts the unique activities first on their frequency then on their names. The top N activities are then selected by the probabilistic inductive miner for process mining, where N is any positive integer (e.g., 100). The inclusion and exclusion constraints allow the user to define what activities should or should not be used in the process mining. Accordingly, prior to selecting the top N activities for process mining, the inclusion and exclusion constraints are applied such that the activities defined by the inclusion constraints are selected and the activities defined by the exclusion constraints are not selected. This ensures the activities to be included are always used in the process mining and the activities to be excluded are not.

At step 208, the process tree is output. In one embodiment, the process tree may be output by, for example, displaying the process tree on a display device of a computer system, storing the process tree on a memory or storage of a computer system, or by transmitting the process tree to a remote computer system. In one embodiment, the process tree is output to a conformance checking system for performing conformance checking of the process based on the output process tree.

In some embodiments, the process tree may be converted to a process model, e.g., using known techniques. The process model may be, for example, a BPMN (business process modeling notation) model or BPMN-like model.

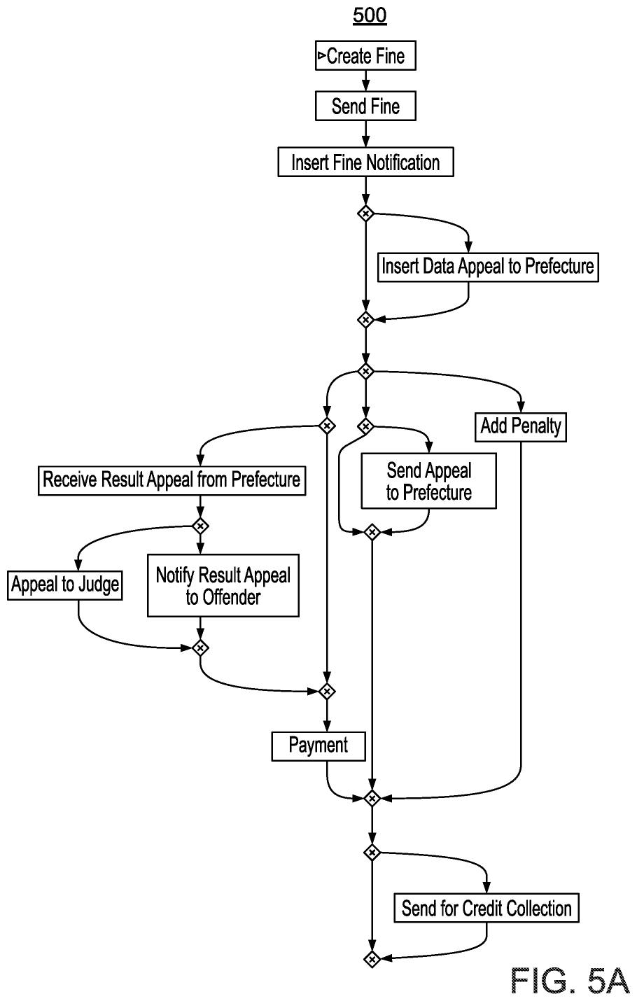

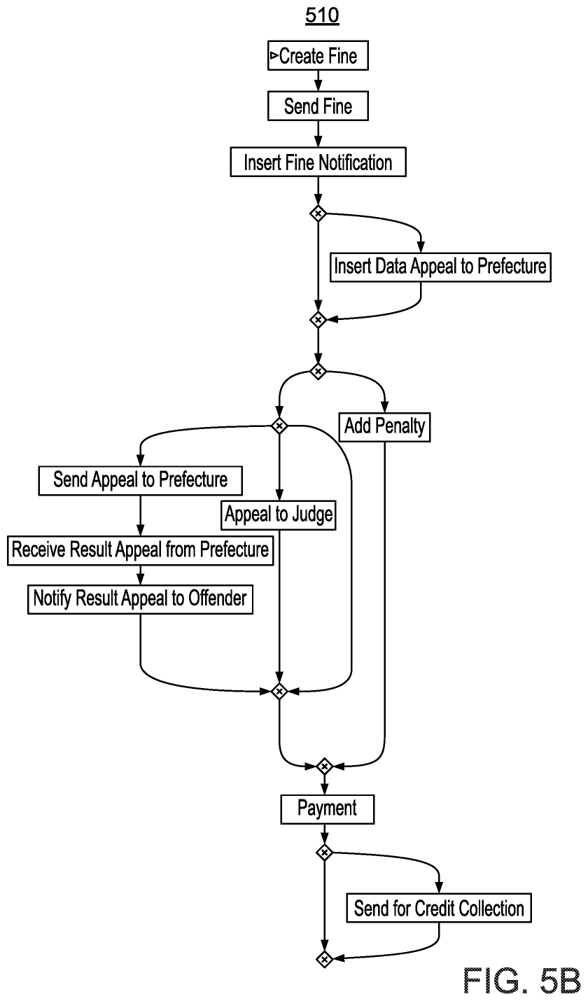

FIG. 5A shows a process tree 500 of a particular process generated using a conventional, unconstrained probabilistic inductive miner and FIG. 5B shows a process tree 510 of the same particular process generated using a constrained probabilistic inductive miner in accordance with one or more embodiments. Process tree 510 of FIG. 5B may be generated according to method 200 of FIG. 2. The constrained probabilistic inductive miner used to generate process tree 510 is constrained by a user with the following user constraints:
Send Appeal to Prefecture→Receive Result Appeal from Prefecture→Notify Result Appeal to Offender
Appeal to Judge→Payment
Add Penalty→Payment
Send Appeal to Prefecture→Payment
Notify Result Appeal to Offender→Payment
Receive Result Appeal from Prefecture→Payment
   Process tree 510 of FIG. 5B is a more accurate representation of the execution of the particular process as compared to process tree 500 of FIG. 5A.

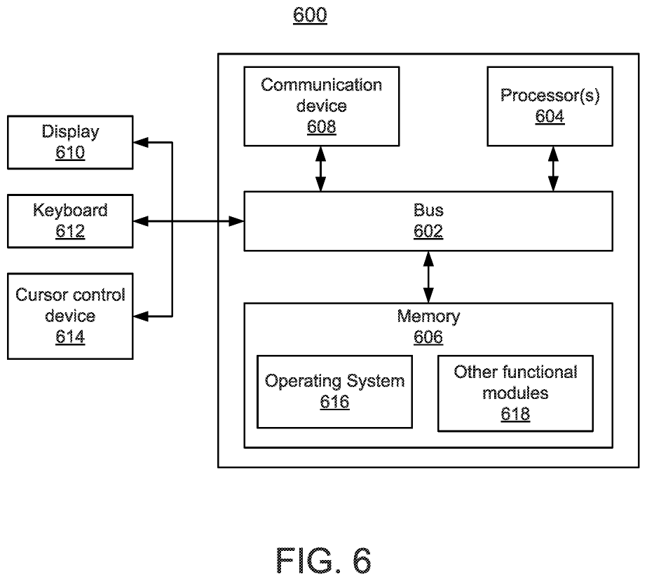

FIG. 6 is a block diagram illustrating a computing system 600 configured to execute the methods, workflows, and processes described herein, including FIG. 2, according to an embodiment of the present invention. In some embodiments, computing system 600 may be one or more of the computing systems depicted and/or described herein. Computing system 600 includes a bus 602 or other communication mechanism for communicating information, and processor(s) 604 coupled to bus 602 for processing information. Processor(s) 604 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 604 may also have multiple processing cores, and at least some of the cores may be configured to perform specific functions. Multi-parallel processing may be used in some embodiments.

Computing system 600 further includes a memory 606 for storing information and instructions to be executed by processor(s) 604. Memory 606 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 604 and may include volatile media, non-volatile media, or both. The media may also be removable, non-removable, or both.

Additionally, computing system 600 includes a communication device 608, such as a transceiver, to provide access to a communications network via a wireless and/or wired connection according to any currently existing or future-implemented communications standard and/or protocol.

Processor(s) 604 are further coupled via bus 602 to a display 610 that is suitable for displaying information to a user. Display 610 may also be configured as a touch display and/or any suitable haptic I/O (input/output) device.

A keyboard 612 and a cursor control device 614, such as a computer mouse, a touchpad, etc., are further coupled to bus 602 to enable a user to interface with computing system. However, in certain embodiments, a physical keyboard and mouse may not be present, and the user may interact with the device solely through display 610 and/or a touchpad (not shown). Any type and combination of input devices may be used as a matter of design choice. In certain embodiments, no physical input device and/or display is present. For instance, the user may interact with computing system 600 remotely via another computing system in communication therewith, or computing system 600 may operate autonomously.

Memory 606 stores software modules that provide functionality when executed by processor(s) 604. The modules include an operating system 616 for computing system 600 and one or more additional functional modules 618 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer-implemented method comprising:
receiving an event log of execution of a process;
receiving user constraints on one or more activities of the process from a user;
generating a process tree from the event log based on the user constraints; and
outputting the process tree,
wherein the user constraints comprise at least one of inclusion constraints defining one or more activities that must be represented in the process tree or exclusion constraints defining one or more activities that must not be represented in the process tree.

2. The computer-implemented method of claim 1, wherein generating a process tree from the event log based on the user constraints comprises:
extracting a plurality of activities from the event log;
selecting activities from the plurality of activities based on the inclusion constraints and the exclusion constraints; and
generating the process tree based on the selected activities.

3. The computer-implemented method of claim 2, wherein the selected activities comprise the one or more activities that must be represented in the process tree.

4. The computer-implemented method of claim 2, wherein the selected activities do not comprise the one or more activities that must not be represented in the process tree.

5. The computer-implemented method of claim 1, wherein the process is an RPA (robotic process automation) process.

6. An apparatus comprising:
a memory storing computer instructions; and
at least one processor configured to execute the computer instructions, the computer instructions configured to cause the at least one processor to perform operations of:
receiving an event log of execution of a process;
receiving user constraints on one or more activities of the process from a user;
generating a process tree from the event log based on the user constraints; and
outputting the process tree,
wherein the user constraints comprise at least one of inclusion constraints defining one or more activities that must be represented in the process tree or exclusion constraints defining one or more activities that must not be represented in the process tree.

7. The apparatus of claim 6, wherein generating a process tree from the event log based on the user constraints comprises:
extracting a plurality of activities from the event log;
selecting activities from the plurality of activities based on the inclusion constraints and the exclusion constraints; and
generating the process tree based on the selected activities.

8. The apparatus of claim 7, wherein the selected activities comprise the one or more activities that must be represented in the process tree.

9. The apparatus of claim 7, wherein the selected activities do not comprise the one or more activities that must not be represented in the process tree.

10. The apparatus of claim 6, wherein the process is an RPA (robotic process automation) process.

11. A non-transitory computer-readable medium storing computer program instructions, the computer program instructions, when executed on at least one processor, cause the at least one processor to perform operations comprising:
receiving an event log of execution of a process;
receiving user constraints on one or more activities of the process from a user;
generating a process tree from the event log based on the user constraints; and
outputting the process tree,
wherein the user constraints comprise at least one of inclusion constraints defining one or more activities that must be represented in the process tree or exclusion constraints defining one or more activities that must not be represented in the process tree.

12. The non-transitory computer-readable medium of claim 11, wherein generating a process tree from the event log based on the user constraints comprises:
extracting a plurality of activities from the event log;
selecting activities from the plurality of activities based on the inclusion constraints and the exclusion constraints; and
generating the process tree based on the selected activities.

13. The non-transitory computer-readable medium of claim 12, wherein the selected activities comprise the one or more activities that must be represented in the process tree.

14. The non-transitory computer-readable medium of claim 12, wherein the selected activities do not comprise the one or more activities that must not be represented in the process tree.

15. The non-transitory computer-readable medium of claim 11, wherein the process is an RPA (robotic process automation) process.
